(19) United States
(12) Patent Application Publication
(10) Pub. No.: US 2025/0266471 A1
(43) Pub. Date: Aug. 21, 2025

(54) ELECTROCHEMICAL CELL AND SEPARATOR-EQUIPPED ELECTROCHEMICAL CELL

(71) Applicant: NGK INSULATORS, LTD., Nagoya-shi (JP)

(72) Inventors: Kazuhiro MIZUKI, Kuwana-shi (JP); Shiko IWASAKI, Nagoya-shi (JP); Naoya AKIYAMA, Nagoya-shi (JP); Masayuki SHINKAI, Kanie-cho (JP); Shinji FUJISAKI, Kuwana-shi (JP); Makoto OHMORI, Nagoya-shi (JP)

(21) Appl. No.: 19/198,710

(22) Filed: May 5, 2025

Related U.S. Application Data
(63) Continuation of application No. PCT/JP2023/041813, filed on Nov. 21, 2023.

(30) Foreign Application Priority Data
Nov. 30, 2022 (JP) 2022-191611

(51) Int. Cl. H01M 8/0273; H01M 8/0206; H01M 8/0282

(52) U.S. Cl. CPC H01M 8/0273; H01M 8/0206; H01M 8/0282

(57) ABSTRACT

An electrochemical cell including a current collector layer, a gas sealing layer surrounding a side periphery of the current collector layer, a frame body surrounding a side periphery of the gas sealing layer, a first electrode layer disposed on the current collector layer, an electrolyte layer disposed on the first electrode layer; and a second electrode layer disposed on an opposite side to the first electrode layer with respect to the electrolyte layer.

### CROSS-REFERENCE TO RELATED APPLICATION

This is a continuation of PCT/JP2023/041813, filed Nov. 21, 2023, which claims priority from Japanese Application No. 2022-191611, filed Nov. 30, 2022 the entire content of which is hereby incorporated by reference.

### TECHNICAL FIELD

The present invention relates to an electrochemical cell and a separator-equipped electrochemical cell.

### BACKGROUND ART

Conventionally, electrochemical cells each including an electrolyte layer disposed between a first electrode layer and a second electrode layer (e.g., electrolytic cells, fuel batteries) have been known (see JP 2014-049322A, for example). An electrochemical cell is bonded to a metal separator that separates a space on the first electrode layer side and a space on the second electrode layer side from each other and is electrically connected to the first electrode layer.

### SUMMARY

In an electrochemical sells described in JP 2014-049322A, a gas flowing into a first electrode layer from a space on the first electrode layer side returns to a space on a hydrogen electrode side from a side surface of the first electrode layer, and thus the efficiency of gas supply to the first electrode layer is low.

An object of the present invention is to provide an electrochemical cell and a separator-equipped electrochemical cell with which the efficiency of gas supply can be improved.

An electrochemical cell according to a first aspect of the present invention including a current collector layer, a gas sealing layer surrounding a side periphery of the current collector layer, a frame body surrounding a side periphery of the gas sealing layer, a first electrode layer disposed on the current collector layer, an electrolyte layer disposed on the first electrode layer, and a second electrode layer disposed on an opposite side to the first electrode layer with respect to the electrolyte layer.

An electrochemical cell according to a second aspect of the present invention is according to the first aspect, in which a porosity of the gas sealing layer is 5% or less.

An electrochemical cell according to a third aspect of the present invention is according to the first or second aspect, in which the gas sealing layer contains a first constituent element contained in the current collector layer and a second constituent element contained in the frame body.

An electrochemical cell according to a fourth aspect of the present invention is according to the third aspect, in which the gas sealing layer includes a composite oxide containing the first constituent element and the second constituent element.

An electrochemical cell according to a fourth aspect of the present invention is according to any one of the first to fourth aspects, in which a coefficient of thermal expansion of the gas sealing layer is between a coefficient of thermal expansion of the current collector layer and a coefficient of thermal expansion of the frame body.

An electrochemical cell according to the fifth aspect of the present invention is according to any one of the first to fifth aspects, in which the frame body has insulating properties.

An electrochemical cell according to a seventh aspect of the present invention is according to any one of the first to sixth aspects, in which a porosity of the frame body is 15% or less.

An electrochemical cell according to an eighth aspect of the present invention is according to any one of the first to seventh aspects, in which a thickness of the current collector layer is greater than a thickness of the first electrode layer, a thickness of the electrolyte layer, and a thickness of the second electrode layer.

A separator-equipped electrochemical cell according to a ninth aspect of the present invention includes the electrochemical cell according to any one of the first to eighth aspects, a metal separator electrically connected to the current collector layer, and a sealing portion sealing a gap between the electrolyte layer and the metal separator.

According to the present invention, it is possible to provide an electrochemical cell with which an efficiency of gas supply can be improved.

### BRIEF DESCRIPTION OF DRAWINGS

FIG. 1 is a cross-sectional view of a separator-equipped electrolytic cell according to Embodiment 1.

FIG. 2 is a perspective view of a frame body according to Embodiment 1.

FIG. 3 is a cross-sectional view of a separator-equipped electrolytic cell according to

### Variation 2.

FIG. 4 is a cross-sectional view of a separator-equipped electrolytic cell according to Variation 2.

### DESCRIPTION OF EMBODIMENTS

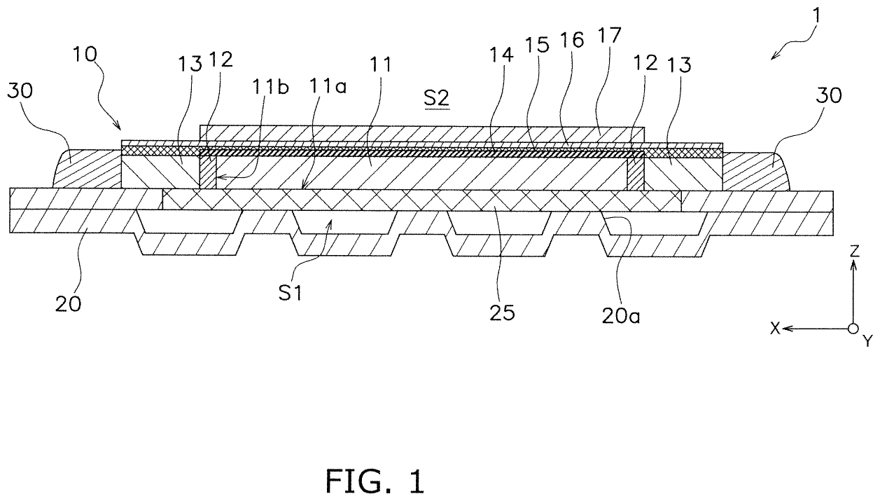

FIG. 1 is a cross-sectional view of a separator-equipped electrolytic cell 1 according to an embodiment. The separator-equipped electrolytic cell 1 is an example of the “separator-equipped electrochemical cell” according to the present invention.

The separator-equipped electrolytic cell 1 includes an electrolytic cell 10, a metal separator 20, a current collector member 25, and a sealing portion 30. The electrolytic cell 10 is an example of the “electrochemical cell” according to the present invention. A cell stack (not shown) can be formed by stacking a plurality of separator-equipped electrolytic cells 1 in the Z-axis direction perpendicular to the X-axis direction and the Y-axis direction.

### Electrolytic Cell 10

As shown in FIG. 1, the electrolytic cell 10 has a hydrogen electrode current collector layer 11, a gas sealing layer 12, a frame body 13, a hydrogen electrode active layer 14, an electrolyte layer 15, a reaction prevention layer 16, and an oxygen electrode layer 17. The hydrogen electrode current collector layer 11 is an example of the “current collector layer” according to the present invention. The hydrogen electrode active layer 14 is an example of the “first electrode layer” according to the present invention. The oxygen electrode layer 17 is an example of the “second electrode layer” in the present invention.

The hydrogen electrode current collector layer 11, the hydrogen electrode active layer 14, the electrolyte layer 15, the reaction prevention layer 16, and the oxygen electrode layer 17 are stacked in this order in the Z-axis direction. The hydrogen electrode current collector layer 11, the frame body 13, the hydrogen electrode active layer 14, the electrolyte layer 15, and the oxygen electrode layer 17 are essential components, and the reaction prevention layer 16 is an optional component.

### Hydrogen Electrode Current Collector Layer 11

The hydrogen electrode current collector layer 11 has a plate shape. The hydrogen electrode current collector layer 11 has a main surface 11a and a side surface 11b. The main surface 11a faces the metal separator 20. The side surface 11b is continuous with the main surface 11a. The side surface 11b is covered with the gas sealing layer 12. In the present embodiment, the side surface 11b is substantially perpendicular to the main surface 11a, but may be inclined inward or outward relative to the main surface 11a.

The hydrogen electrode current collector layer 11 is electrically connected to the metal separator 20 via the current collector member 25. A hydrogen electrode side space S1 is formed between the hydrogen electrode current collector layer 11 and the metal separator 20.

The hydrogen electrode current collector layer 11 has, in addition to the current collecting function, a gas diffusion function of diffusing the source gas supplied to the hydrogen electrode side space S1 toward the hydrogen electrode active layer 14.

The hydrogen electrode current collector layer 11 is a porous body having electron conductivity. The hydrogen electrode current collector layer 11 contains nickel (Ni). In the case of co-electrolysis, Ni functions as an electron-conducting material, and also functions as a thermocatalyst that promotes a thermal reaction between H₂ generated in the hydrogen electrode active layer 14 and CO₂ contained in the source gas to maintain a gas composition suitable for methanation, Fischer-Tropsch (FT) synthesis, or the like. The Ni contained in the hydrogen electrode current collector layer 11 is basically present in the state of metal Ni during the operation of the electrolytic cell 10, but a part thereof may be present in the state of nickel oxide (NiO).

The hydrogen electrode current collector layer 11 contains ceramic in addition to nickel (Ni). The ceramic may have ionic conductivity. Examples of the ceramic that can be used include yttria (Y₂O₃), magnesia (MgO), ferric oxide (Fe₂O₃), zirconia (ZrO₂, including partially stabilized zirconia), yttria-stabilized zirconia (YSZ), calcia-stabilized zirconia (CSZ), scandia-stabilized zirconia (ScSZ), gadolinium-doped ceria (GDC), samarium-doped ceria (SDC), and a mixed material obtained by combining two or more of these.

The porosity of the hydrogen electrode current collector layer 11 is not particularly limited, but may be, for example, 20% or more and 40% or less.

The thickness of the hydrogen electrode current collector layer 11 is not particularly limited, but may be, for example, 150 μm or more and 1500 μm or less. In the present embodiment, the hydrogen electrode current collector layer 11 functions as a support of the electrolytic cell 10 together with the gas sealing layer 12 and the frame body 13. In the Z-axis direction, the thickness of the hydrogen electrode current collector layer 11 may be larger than the thickness of each of the hydrogen electrode active layer 14, the electrolyte layer 15, the reaction prevention layer 16, and the oxygen electrode layer 17. The electrolytic cell 10 according to the present embodiment is a so-called anode-supported cell. However, the electrolytic cell 10 may be a so-called electrolyte-supported cell or a so-called cathode-supported cell.

The method of forming the hydrogen electrode current collector layer 11 is not particularly limited, and tape molding, screen printing, cast molding, dry pressing, or the like can be used.

### Gas Sealing Layer 12

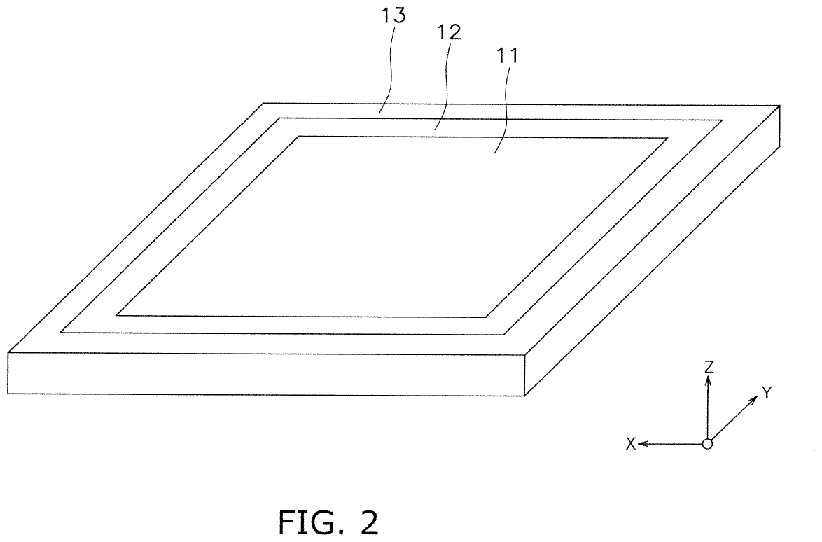

FIG. 2 is a perspective view of the gas sealing layer 12 surrounding a side periphery of the hydrogen electrode current collector layer 11. The gas sealing layer 12 surrounds the side periphery of the hydrogen electrode current collector layer 11. The side periphery of the hydrogen electrode current collector layer 11 means the periphery of the side surface 11b. In the present embodiment, the gas sealing layer 12 functions as a support of the electrolytic cell 10 together with the hydrogen electrode current collector layer 11 and the frame body 13.

The gas sealing layer 12 covers the side surface 11b of the hydrogen electrode current collector layer 11. The gas sealing layer 12 preferably covers the entire side surface 11b of the hydrogen electrode current collector layer 11, but may cover at least a part of the side surface 11b of the hydrogen electrode current collector layer 11.

In the present embodiment, the planar shape of the gas sealing layer 12 is a rectangle, but may be a circle, an ellipse, a polygon having three or more angles, or the like depending on the planar shape of the hydrogen electrode current collector layer 11.

The gas sealing layer 12 is a dense body having gas sealing properties. Accordingly, the source gas flowing from on the hydrogen electrode side space S1 into the hydrogen electrode current collector layer 11 can be prevented from returning from the side surface 11b of the hydrogen electrode current collector layer 11 to the hydrogen electrode side space S1. Therefore, the efficiency of gas supply from the hydrogen electrode current collector layer 11 to the hydrogen electrode active layer 14 can be improved. In addition, since the bonding area between the gas sealing layer 12 and each of the hydrogen electrode current collector layer 11 and the frame body 13 can be increased, the bondability between the gas sealing layer 12 and each of the hydrogen electrode current collector layer 11 and the frame body 13 can be improved. From these viewpoints, the porosity of the gas sealing layer 12 is preferably 5% or less, and more preferably 2% or less.

The gas sealing layer 12 preferably contains the first constituent element contained in the hydrogen electrode current collector layer 11 and the second constituent element contained in the frame body 13. This makes it possible to further improve the bondability between the gas sealing layer 12 and each of the hydrogen electrode current collector layer 11 and the frame body 13.

In this case, the gas sealing layer 12 may contain a composite oxide containing the first constituent element and the second constituent element. Since the gas sealing layer 12 contains such a composite oxide, the progress of the reaction at the time of sintering due to the eutectic point is promoted, and a stronger interface is formed.

The thermal expansion coefficient of the gas sealing layer 12 is preferably a value between the thermal expansion coefficient of the hydrogen electrode current collector layer 11 and the thermal expansion coefficient of the frame body 13. As a result, during the operation of the electrolytic cell 10a, the thermal stresses caused by the difference in thermal expansion coefficient between the hydrogen electrode current collector layer 11 and the frame body 13 can be alleviated in the gas sealing layer 12, so that the bondability between the gas sealing layer 12 and each of the hydrogen electrode current collector layer 11 and the frame body 13 can be further improved.

The gas sealing layer 12 can be made of, for example, nickel (Ni), nickel oxide (NiO), yttria (Y₂O₃), magnesia (MgO), iron oxides (Fe₂O₃), zirconia (ZrO₂, including partially stabilized zirconia), alumina (Al₂O₃), calcia (CaO), silica (Si₂O₃), spinels (MgAl₂O₄ and NiAl₂O₄), YAG (Y₃Al₅O₁₂), YAM (Y₄Al₂O₉), a nickel oxide-magnesia solid-solution (MgₓNi₍₁₋ₓ₎O[0<x<1]), a mixed material obtained by combining two or more thereof, or the like.

The method for forming the gas sealing layer 12 is not particularly limited, and tape molding, screen printing, slip cast molding, dry pressing, or the like can be used.

### Frame Body 13

As shown in FIG. 1, the frame body 13 is disposed on the metal separator 20. The frame body 13 is positioned relative to the metal separator 20 by the sealing portion 30.

The frame body 13 has a frame-like shape. As shown in FIGS. 1 and 2, the frame body 13 surrounds a side periphery of the gas sealing layer 12. In the present embodiment, the frame body 13 functions as a support of the electrolytic cell 10 together with the hydrogen electrode current collector layer 11 and the gas sealing layer 12.

In the present embodiment, the planar shape of the frame body 13 is a rectangular shape, but may be a circular shape, an elliptical shape, a polygonal shape having three or more corners, or the like depending on the planar shape of the hydrogen electrode current collector layer 11 and the gas sealing layer 12.

Examples of the insulating material include forsterite (Mg₂SiO₄), magnesium silicate (MgSiO₃), zirconia (ZrO₂, including partially stabilized zirconia), magnesia (MgO), spinels (MgAl₂O₄ and NiAl₂O₄), yttria-stabilized zirconia (YSZ), calcia-stabilized zirconia (CSZ), nickel (Ni), nickel oxide (NiO), alumina (Al₂O₃), nickel oxide-magnesia solid solutions (MgₓNi₍₁₋ₓ₎O[0<x<1]), and mixed materials obtained by combining two or more of these materials.

It is preferable that the frame body 13 has electronic insulating properties. Accordingly, it is possible to prevent the occurrence of a short circuit between the hydrogen electrode current collector layer 11 and the metal separator 20. Therefore, it is not necessary to impart a short circuit prevention function to the sealing portion 30 to be described later, and thus it is possible to simplify the configuration of the sealing portion 30. Therefore, it is possible to easily insulate the electrolytic cell 10 from the metal separator 20. The electronic conductivity of the frame body 13 is not particularly limited as long as it is sufficiently low, but may be 0.1 S/m or less.

The porosity of the frame body 13 is not particularly limited, but may be, for example, 0.1% or more and 15% or less. The porosity of the frame body 13 is preferably 5% or less. As a result, gas sealing properties can be imparted to the frame body 13 in addition to the gas sealing layer 12, and therefore, it is possible to further suppress the source gas flowing into the hydrogen electrode current collector layer 11 from the hydrogen electrode side space S1 from passing through the frame body 13 and returning to the hydrogen electrode side space S1.

The width of the frame body 13 in the X-axis direction is not particularly limited, and may be, for example, 0.5 mm or more and 10 mm or less.

The method for forming the frame body 13 is not particularly limited, and tape molding, screen printing, cast molding, a dry pressing method, or the like can be used.

### Hydrogen Electrode Active Layer 14

The hydrogen electrode active layer 14 functions as a cathode. The hydrogen electrode active layer 14 is disposed on the hydrogen electrode current collector layer 11. The hydrogen electrode active layer 14 is covered with the electrolyte layer 15.

The source gas is supplied to the hydrogen electrode active layer 14 via the hydrogen electrode current collector layer 11. In the present embodiment, the source gas contains at least H₂O.

When the source gas contains only H₂O, the hydrogen electrode active layer 14 generates H₂ from the source gas in accordance with the electrochemical reactions of water electrolysis represented by the following formula (1).
Hydrogen electrode active layer 14:H₂O+2e⁻→H₂+O²⁻. . . (1)

When the source gas contains CO₂ in addition to H₂O, the hydrogen electrode active layer 14 generates H₂, CO, and O²⁻ from the source gas according to the electrochemical reactions of co-electrolysis shown in the following formulae (2), (3), and (4).
Hydrogen electrode active layer 14: CO₂+H₂O+4e⁻→CO+H₂+2O²⁻. . . (2)
H₂O electrochemical reaction: H₂O+2e⁻→H₂+O²⁻. . . (3)
CO₂ electrochemical reaction: CO₂+2e⁻→CO+O²⁻. . . (4)

The hydrogen electrode active layer 14 is a porous body having electron conductivity. The hydrogen electrode active layer 14 may have ion conductivity. The hydrogen electrode active layer 14 can be made of, for example, YSZ, CSZ, ScSZ, GDC, (SDC), (La, Sr) (Cr, Mn)O₃, (La, Sr) TiO₃, Sr₂(Fe, Mo)₂O₆, (La, Sr)VO₃, (La, Sr)FeO₃, a mixed material obtained by combining two or more of these materials, or a composite of one or more of these materials and NiO.

The porosity of the hydrogen electrode active layer 14 is not particularly limited, and may be, for example, 20% or more and 40% or less. The thickness of the hydrogen electrode active layer 14 is not particularly limited, but may be, for example, 5 μm or more and 10 μm or less.

The method for forming the hydrogen electrode active layer 14 is not particularly limited, and tape molding, screen printing, cast molding, dry pressing, or the like can be used.

### Electrolyte Layer 15

The electrolyte layer 15 is disposed between the hydrogen electrode active layer 14 and the oxygen electrode layer 17. In the present embodiment, since the reaction prevention layer 16 is disposed between the electrolyte layer 15 and the oxygen electrode layer 17, the electrolyte layer 15 is disposed between the hydrogen electrode active layer 14 and the reaction prevention layer 16, and is connected to the hydrogen electrode active layer 14 and the reaction prevention layer 16.

The electrolyte layer 15 covers the hydrogen electrode active layer 14. As shown in FIG. 1, the electrolyte layer 15 preferably covers the entire surface of the hydrogen electrode active layer 14. The outer peripheral portion of the electrolyte layer 15 is connected to the frame body 13.

The electrolyte layer 15 has a function of transmitting O²⁻ generated in the hydrogen electrode active layer 14 to the oxygen electrode layer 17 side. The electrolyte layer 15 is a dense body having ionic conductivity and not having electron conductivity. The electrolyte layer 15 may be made of, for example, YSZ, GDC, ScSZ, SDC, or lanthanum gallate (LSGM).

The porosity of the electrolyte layer 15 is not particularly limited, but may be, for example, 0.1% or more and 7% or less. The thickness of the electrolyte layer 15 is not particularly limited, but may be, for example, 1 μm or more and 100 μm or less.

The method for forming the electrolyte layer 15 is not particularly limited, and tape molding, screen printing, cast molding, dry pressing, or the like can be used.

### Reaction Prevention Layer 16

The reaction prevention layer 16 is disposed between the electrolyte layer 15 and the oxygen electrode layer 17. The reaction prevention layer 16 is disposed on the opposite side to the hydrogen electrode active layer 14 with respect to the electrolyte layer 15. The reaction prevention layer 16 prevents constituent elements of the electrolyte layer 15 from reacting with constituent elements of the oxygen electrode layer 17 to form a layer having a large electric resistance.

The reaction prevention layer 16 is made of an ion conductive material. The reaction prevention layer 16 can be made of GDC, SDC, or the like.

The porosity of the reaction prevention layer 16 is not particularly limited, but may be, for example, 0.1% or more and 50% or less. The thickness of The reaction prevention layer 16 is not particularly limited, and may be, for example, 1 μm or more and 50 μm or less.

The method for forming The reaction prevention layer 16 is not particularly limited, and tape molding, screen printing, cast molding, a dry pressing method, or the like can be used.

### Oxygen Electrode Layer 17

The oxygen electrode layer 17 functions as an anode. The oxygen electrode layer 17 is disposed on the opposite side to the hydrogen electrode active layer 14 with respect to the electrolyte layer 15. In the present embodiment, since The reaction prevention layer 16 is disposed between the electrolyte layer 15 and the oxygen electrode layer 17, the oxygen electrode layer 17 is connected to The reaction prevention layer 16. In a case where The reaction prevention layer 16 is not disposed between the electrolyte layer 15 and the oxygen electrode layer 17, the oxygen electrode layer 17 is connected to the electrolyte layer 15.

The oxygen electrode layer 17 generates O₂ from O²⁻ transferred from the hydrogen electrode active layer 14 via the electrolyte layer 14, according to the chemical reactions of the following formula (5). The O₂ generated in the oxygen electrode layer 17 is released to the oxygen electrode side space S2.
Oxygen electrode layer 17: 2O²⁻→O₂+4e⁺ . . . (5)

The oxygen electrode layer 17 is a porous body having ion conductivity and electron conductivity. The oxygen electrode layer 17 can be made of, for example, a composite material of one or more of (La, Sr) (Co, Fe)O₃, (La, Sr)FeO₃, La(Ni, Fe)O₃, (La, Sr)CoO₃, and (Sm, Sr)CoO₃ and an ion conductive material (e.g., GDC).

The porosity of the oxygen electrode layer 17 is not particularly limited, but may be, for example, 20% or more and 60% or less. The thickness of the oxygen electrode layer 17 is not particularly limited, and may be, for example, 1 μm or more and 100 μm or less.

The method for forming the oxygen electrode layer 17 is not particularly limited, and tape molding, screen printing, cast molding, dry pressing, or the like can be used.

### Metal Separator 20

The metal separator 20 is electrically connected to the hydrogen electrode current collector layer 11 via the current collector member 25. The metal separator 20 has a connection portion 20a that is in contact with the current collector member 25.

The metal separator 20 is made of a metal material having electron conductivity. The metal separator 20 can be made of, for example, an alloy material containing Cr (chromium). Examples of such an alloy material include Fe—Cr alloy steel (e.g., stainless steel) and Ni—Cr alloy steel. The content of Cr in the metal separator 20 is not particularly limited, but may be 4 mass % or more and 30 mass % or less.

The metal separator 20 may also contain Ti (titanium) or Zr (zirconium). The content of Ti in the metal separator 20 is not particularly limited, but may be 0.01 mol % or more and 1.0 mol % or less. The content of Al in the metal separator 20 is not particularly limited, but may be 0.01 mol % or more and 0.4 mol % or less. The metal separator 20 may contain Ti in the form of TiO₂ (titania) or may contain Zr as in the form of ZrO₂ (zirconia).

The metal separator 20 may have, on its surface, an oxide film formed by oxidation of constituent elements of the metal separator 20. A typical example of the oxide film is a chromium oxide film. The chromium oxide film covers at least a part of the surface of the metal separator 20.

### Current Collector Member 25

The current collector member 25 electrically connects the hydrogen electrode current collector layer 11 and the metal separator 20. As shown in FIG. 1, the current collector member 25 is disposed in the S1 of the hydrogen electrode side space between the hydrogen electrode current collector layer 11 and the metal separator 20. The current collector member 25 is in contact with the main surface 11a of the hydrogen electrode current collector layer 11 and the connection portion 20a of the metal separator 20.

The current collector member 25 has electron conductivity and air permeability. As the current collector member 25, for example, a member of nickel, a nickel alloy, stainless steel, or the like can be used. The size, shape, and position of the current collector member 25 can be changed as appropriate. For example, in the present embodiment, the current collector member 25 is in contact with both the hydrogen electrode current collector layer 11 and the frame body 13, but does not need to be in contact with the frame body 13.

### Sealing Portion 30

The sealing portion 30 positions the frame body 13 relative to the metal separator 20. The sealing portion 30 is a dense body. The sealing portion 30 seals a gap between the electrolytic cell 10 and the metal separator 20. This prevents gases from mixing between the hydrogen electrode side space S1 and the oxygen electrode side space S2 through the gaps between the electrolytic cell 10 and the metal separator 20. In addition, in a case where the frame body 13 has air permeability, mixing of gas through the frame body 13 itself is prevented by the sealing portion 30.

In the present embodiment, the sealing portion 30 is connected to the frame body 13 and the electrolyte layer 15 of the electrolytic cell 10, but when the frame body 13 does not have air permeability, the sealing portion 30 does not need to be connected to the electrolyte layer 15.

The sealing portion 30 preferably has electronic insulating properties. This makes it possible to more reliably prevent the occurrence of a short circuit between the hydrogen electrode current collector layer 11 and the metal separator 20. However, as described above, when a short circuit between the hydrogen electrode current collector layer 11 and the metal separator 20 can be prevented by the frame body 13, the short circuit preventing function of the sealing portion 30 may be auxiliary.

The sealing portion 30 can be formed of, for example, glass, glass ceramics (crystallized glass), a composite of glass and ceramics, or the like.

### Features

The electrolytic cell 10 includes the gas sealing layer 12 surrounding the side periphery of the hydrogen electrode current collector layer 11. As a result, it is possible to prevent the source gas flowing into the hydrogen electrode current collector layer 11 from the hydrogen electrode side space S1 from returning to the hydrogen electrode side space S1 from the side surface 11b of the hydrogen electrode current collector layer 11. And thus, the efficiency of gas supply from the hydrogen electrode current collector layer 11 to the hydrogen electrode active layer 14 can be improved.

In addition, since the hydrogen electrode current collector layer 11, the gas sealing layer 12 and the frame body 13 function as a support of the electrolytic cell 10, the strength of the electrolytic cell 10 can be improved. Therefore, it is possible to prevent the electrolytic cell 10 from being damaged by an external force when the electrolytic cell 10 is assembled to the metal separator 20 or a thermal stress generated during the operation of the electrolytic cell 10.

Furthermore, when Ni contained in the hydrogen electrode current collector layer 11 aggregates during the operation of the electrolytic cell 10, the hydrogen electrode current collector layer 11 is likely to be deformed, but since the hydrogen electrode current collector layer 11 is surrounded by the gas sealing layer 12 and the frame body 13, the deformation of the hydrogen electrode current collector layer 11 can be suppressed.

### VARIATIONS OF EMBODIMENTS

Although the embodiments of the present invention have been described thus far, the present invention is not limited thereto, and various variations can be made without departing from the gist of the present invention.

### Variation 1

In the above-described embodiments, the gas sealing layer 12 surrounds only the side periphery of the hydrogen electrode current collector layer 11 of the electrolytic cell 10, but the present invention is not limited thereto. The gas sealing layer 12 may surround the side periphery of the hydrogen electrode active layer 14, or may surround the side periphery of the electrolyte layer 15.

### Variation 2

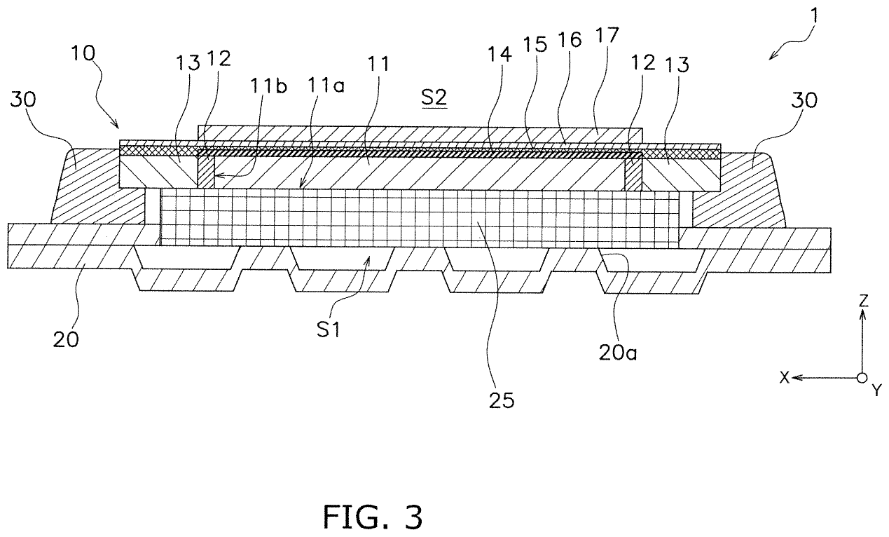

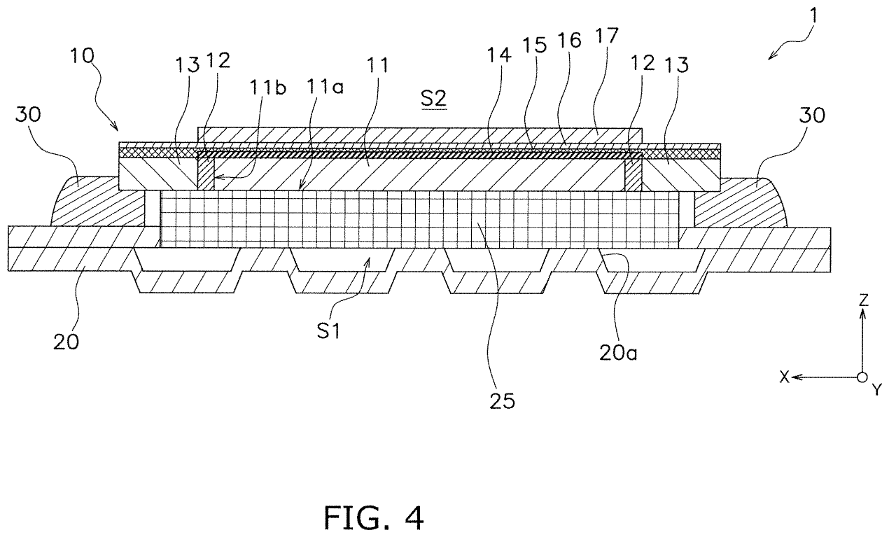

Although the frame body 13 is disposed on the metal separator 20 in the embodiment, the frame body 13 may alternatively be disposed on the sealing portion 30 as shown in FIG. 3. Further, when the frame body 13 does not have air permeability, the sealing portion 30 may be connected to the frame body 13 and may not be connected to the electrolyte layer 15, as shown in FIG. 4.

### Variation 3

In the above-described embodiment, the hydrogen electrode active layer 14 functions as a cathode and the oxygen electrode layer 17 functions as an anode, but the hydrogen electrode active layer 14 may function as an anode and the oxygen electrode layer 17 may function as a cathode. In this case, the constituent materials of the hydrogen electrode active layer 14 and the oxygen electrode layer 17 are exchanged, and the source gas is caused to flow on the outer surface of the hydrogen electrode active layer 14. The hydrogen electrode current collector layer 11 functions as an oxygen electrode current collector layer, while the configuration and function of the oxygen electrode current collector layer are the same as the configuration and function of the hydrogen electrode current collector layer 11 described in the above embodiment.

### Variation 4

In the above-described embodiment, the electrolytic cell 10 has been described as an example of the electrochemical cell, but the electrochemical cell is not limited to the electrolytic cell. An electrochemical cell is a general term for an element in which a pair of electrodes are arranged so that an electromotive force is generated from an overall oxidation reduction reaction in order to convert electric energy into chemical energy, and an element for converting chemical energy into electric energy. Accordingly, the electrochemical cell includes, for example, a fuel cell using oxide ions or protons as carriers.

### REFERENCE SIGNS LIST

1 Separator-equipped electrolytic cell
10 Electrolytic cell
11 Hydrogen electrode current collector layer
12 Gas sealing layer
13 Frame body
14 Hydrogen electrode active layer
15 Electrolyte layer
16 Reaction prevention layer
17 Oxygen electrode layer
20 Metal separator
30 Sealing portion

1. An electrochemical cell comprising:
a current collector layer;
a gas sealing layer surrounding a side periphery of the current collector layer;
a frame body surrounding a side periphery of the gas sealing layer;
a first electrode layer disposed on the current collector layer;
an electrolyte layer disposed on the first electrode layer; and
a second electrode layer disposed on an opposite side to the first electrode layer with respect to the electrolyte layer.

2. The electrochemical cell according to claim 1, wherein
a porosity of the gas sealing layer is 5% or less.

3. The electrochemical cell according to claim 1, wherein
the gas sealing layer contains a first constituent element contained in the current collector layer and a second constituent element contained in the frame body.

4. The electrochemical cell according to claim 3, wherein
the gas sealing layer includes a composite oxide containing the first constituent element and the second constituent element.

5. The electrochemical cell according to claim 1, wherein
a coefficient of thermal expansion of the gas sealing layer is between a coefficient of thermal expansion of the current collector layer and a coefficient of thermal expansion of the frame body.

6. The electrochemical cell according to claim 1, wherein
the frame body has insulating properties.

7. The electrochemical cell according to claim 1, wherein
a porosity of the frame body is 15% or less.

8. The electrochemical cell according to claim 1, wherein
a thickness of the current collector layer is greater than a thickness of the first electrode layer, a thickness of the electrolyte layer, and a thickness of the second electrode layer.

9. A separator-equipped electrochemical cell comprising:
the electrochemical cell according to any one of claim 1;
a metal separator electrically connected to the current collector layer; and
a sealing portion sealing a gap between the electrochemical cell and the metal separator.
